(19) United States
(12) Patent Application Publication
(10) Pub. No.: US 2023/0050080 A1
(43) Pub. Date: Feb. 16, 2023

(54) DATA COLLECTION APPARATUS, DATA COLLECTION SYSTEM, DATA COLLECTION METHOD, AND COMPUTER READABLE RECORDING MEDIUM

(71) Applicant: NEC Corporation, Minato-ku, Tokyo (JP)

(72) Inventor: Masatoshi Fukukawa, Tokyo (JP)

(73) Assignee: NEC Corporation, Minato-ku, Tokyo (JP)

(21) Appl. No.: 17/792,232

(22) PCT Filed: Jan. 23, 2020
(86) PCT No.: PCT/JP2020/002228

§ 371 Date: Jul. 12, 2022

(51) Int. Cl. G06Q 50/26; G06Q 10/10; G06Q 10/06

(52) U.S. Cl. CPC G06Q 50/265; G06Q 10/10; G06Q 10/063114

(57) ABSTRACT

A data collection apparatus (1) according to the present disclosure includes: instruction data collection means (31a) for collecting instruction data representing an instruction that a leader has given to a subordinate, and first time information indicating a time at which the instruction was given, the subordinate being a person who works at a site, the leader being a person who leads the subordinate, and the instruction data and the first time information being data and information transmitted from a leader terminal (20) operated by the leader; site work data collection means (31b) for collecting site work data representing work performed by the subordinate at the site, and second time information indicating a time at which the site work data was detected, the site work data and the second time information being data and information transmitted from a subordinate terminal (11) carried by the subordinate.

### TECHNICAL FIELD

The present disclosure relates to a data collection apparatus, a data collection system, a data collection method, and a computer readable recording medium.

### BACKGROUND ART

For example, Patent Literature 1 discloses an apparatus that, in order to understand the situation of a site (e.g., a fire site) in real time, collects site information from the site, accumulates them in a database, extracts main items from the database according to an extracting rule, and generates, in real time, a report in which the extracted main items are arranged in a chronological order.

### CITATION LIST

### Patent Literature

Patent Literature 1: Japanese Unexamined Patent Application Publication No. 2001-184397

### SUMMARY OF INVENTION

### Technical Problem

However, Patent Literature 1 merely discloses to collect and to accumulate site information suitable for understanding the situation of the site in real time. That is, Patent Literature 1 does not disclose any technique or the like that enables a leader (e.g., a leader of a fire brigade), who leads subordinates (e.g., members of the fire brigade) who are working at a site (e.g., a fire site), to collect and accumulate instruction data representing instructions that he/she has given to the subordinates and site work data representing the work (e.g., the activities) that has been performed by the subordinates in response to the instructions in order to use these data after they leave the site (e.g., in order to use these data when they reflect on their work performed at the site).

In view of the above-described problem, an object of the present disclosure is to provide a data collection apparatus, a data collection system, a data collection method, and a computer-readable recording medium capable of enabling a leader (e.g., a leader of a fire brigade), who leads subordinates (e.g., members of the fire brigade) who are working at a site (e.g., a fire site), to collect and accumulate instruction data representing instructions that the leader has given to the subordinates and site work data representing the work (e.g., the activities) that has been performed by the subordinates in response to the instructions.

### Solution to Problem

A data collection apparatus according to a first aspect of the present disclosure includes: instruction data collection means for collecting instruction data representing an instruction that a leader has given to a subordinate, and first time information indicating a time at which the instruction was given, the subordinate being a person who works at a site, the leader being a person who leads the subordinate, and the instruction data and the first time information being data and information transmitted from a leader terminal operated by the leader; site work data collection means for collecting site work data representing work performed by the subordinate at the site, and second time information indicating a time at which the site work data was detected, the site work data and the second time information being data and information transmitted from a subordinate terminal equipped by the subordinate; and a storage device in which the instruction data and the first time information collected by the instruction data collection means, and the site work data and the second time information collected by the site work data collection means are accumulated.

A data collection system according to a second aspect of the present disclosure includes: a leader terminal operated by a leader, the leader being a person who leads a subordinate who works at a site; a subordinate terminal carried by the subordinate; and a data collection apparatus, in which the data collection apparatus includes: instruction data collection means for collecting instruction data representing an instruction that the leader has given to the subordinate, and first time information indicating a time at which the instruction was given, the instruction data and the first time information being data and information transmitted from the leader terminal operated by the leader; site work data collection means for collecting site work data representing work performed by the subordinate at the site, and second time information indicating a time at which the site work data was detected, the site work data and the second time information being data and information transmitted from the subordinate terminal carried by the subordinate; and a storage device in which the instruction data and the first time information collected by the instruction data collection means, and the site work data and the second time information collected by the site work data collection means are accumulated.

A data collection method according to a third aspect of the present disclosure includes: a step of collecting instruction data representing an instruction that a leader has given to a subordinate, and first time information indicating a time at which the instruction was given, the subordinate being a person who works at a site, the leader being a person who leads the subordinate, and the instruction data and the first time information being data and information transmitted from a leader terminal operated by the leader; a step of collecting site work data representing work performed by the subordinate at the site, and second time information indicating a time at which the site work data was detected, the site work data and the second time information being data and information transmitted from a subordinate terminal carried by the subordinate; and a step of accumulating the instruction data and the first time information collected by the instruction data collection means, and the site work data and the second time information collected by the site work data collection means in a storage device.

A computer readable recording medium according to a fourth aspect of the present disclosure stores a program for causing an electronic device including at least one processor to perform: a process for collecting instruction data representing an instruction that a leader has given to a subordinate, and first time information indicating a time at which the instruction was given, the subordinate being a person who works at a site, the leader being a person who leads the subordinate, and the instruction data and the first time information being data and information transmitted from a leader terminal operated by the leader; a process for collecting site work data representing work performed by the subordinate at the site, and second time information indicating a time at which the site work data was detected, the site work data and the second time information being data and information transmitted from a subordinate terminal carried by the subordinate;

and a process for accumulating the instruction data and the first time information collected by the instruction data collection means, and the site work data and the second time information collected by the site work data collection means in a storage device.

### Advantageous Effects of Invention

According to the present invention, it is possible to provide a data collection apparatus, a data collection system, a data collection method, and a computer-readable recording medium capable of enabling a leader (e.g., a leader of a fire brigade), who leads subordinates (e.g., members of the fire brigade) who are working at a site (e.g., a fire site), to collect and accumulate instruction data representing instructions that the leader has given to the subordinates and site work data representing the work (e.g., the activities) that has been performed by the subordinates in response to the instructions.

### BRIEF DESCRIPTION OF DRAWINGS

FIG. 1 is a schematic diagram of a data collection apparatus 30;

FIG. 2 is a detailed configuration diagram of a data collection system 1;

FIG. 3 shows an example of a screen G1 (a virtual image) displayed on a head-up display 10a;

FIG. 4 shows an example of site work data and first time information that a control BOX 11 (a communication unit 11d) transmits to the data collection apparatus 30;

FIG. 5 shows an example of a screen G2 displayed on a display 23;

FIG. 6 shows an example of instruction data and second time information that a captain terminal 20 (a communication unit 24) transmits to the data collection apparatus 30;

FIG. 7 shows an example of each data stored (accumulated) in a storage device 32;

FIG. 8 is a sequence diagram of operations (a site work data collection process) performed by the data collection system 1;

FIG. 9 shows an example of a site (a fire site) where members of a fire brigade work;

FIG. 10 is a sequence diagram of operations (an instruction data collection process) performed by the data collection system 1;

FIG. 11 is a flowchart of operations (a work status data construction process 1) performed by the data collection system 1;

FIG. 12 shows an example of the first work status data;

FIG. 13 is a flowchart of operations (a work status data construction process 2) performed by the data collection system 1;

FIG. 14 is a flowchart of operations (a work status data outputting process) performed by the data collection system 1;

FIG. 15 shows an example of a plurality of first work status data stored in the storage device 32;

FIG. 16 shows a specific example of a plurality of first work status data stored in the storage device 32; and

FIG. 17 shows an example in which, for each of times contained in the first work status data used as a comparison criterion, work in the first work status data used as the comparison criterion at that time is compared with work in the first work status data used as a comparison target at that time.

### EXAMPLE EMBODIMENT

### First Example Embodiment

data collection system 1 according to a first example embodiment of the present invention will be described hereinafter with reference to the attached drawings. The same reference numerals (symbols) are assigned to corresponding components throughout the drawings, and redundant descriptions thereof are omitted.

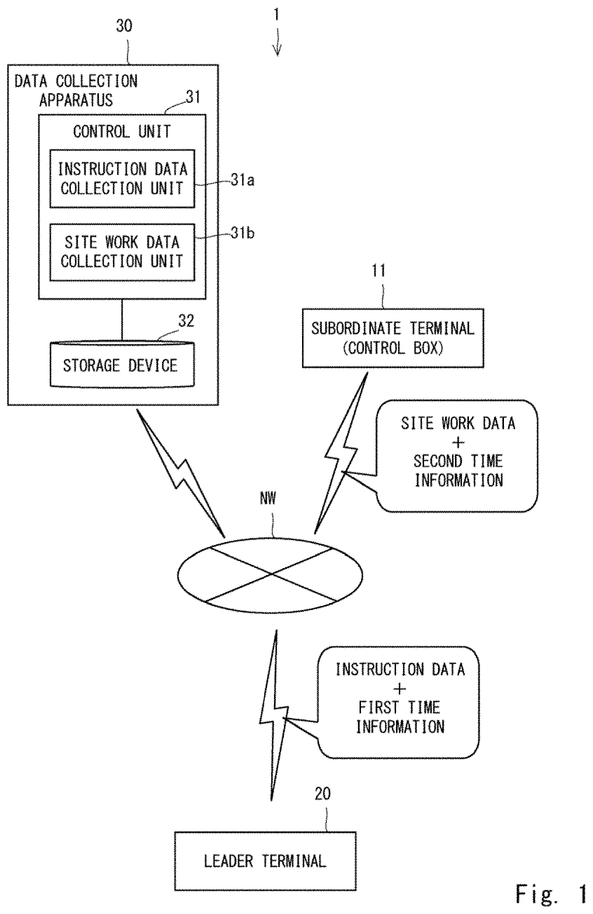

Firstly, a schematic configuration of the data collection system 1 will be described with reference to FIG. 1.

FIG. 1 is a schematic diagram of the data collection system 1.

As shown in FIG. 1, the data collection system 1 includes a subordinate terminal 11 carried by a subordinate (e.g., a member of a fire brigade) who works (i.e., is working) at a site (e.g., a fire site), a captain terminal 20 operated by a leader (e.g., a leader of the fire brigade) who leads the subordinate, and a data collection apparatus 30.

The subordinate terminal 11 transmits site work data representing work performed by subordinates and second time information representing a time at which the site work data is detected (i.e., obtained) through, for example, a communication line NW. The leader terminal 20 transmits instruction data representing an instruction that the leader has given to the subordinates, and first time information indicating a time at which the instruction was given through, for example, the communication line NW.

The data collection apparatus 30 includes an instruction data collection unit 31a that collects instruction data and first time information transmitted from the leader terminal 20 through, for example, the radio communication line (NW), a site work data collection unit 31b that collects site work data and second time information that have been transmitted from the subordinate terminal 11 through, for example, the radio communication line (NW), and a storage device 32 in which the instruction data and the first time information collected by the instruction data collection unit 31a, and the site work data and second time information collected by the site work data collection unit 31b, are accumulated.

According to the first example embodiment, it is possible to enable a leader (e.g., a leader of a fire brigade), who leads subordinates (e.g., members of the fire brigade) who are working at a site (e.g., a fire site), to collect and accumulate instruction data representing an instruction that the leader has given to the subordinates and site work data representing work (e.g., activities) that has been performed by the subordinates in response to the instruction. The above-described accumulated site work data can be used in a variety of ways after they leave the site. For example, the accumulated site work data can be used, for example, for retrospectives of site work (a review of when and what actions were taken at the disaster site and their appropriateness).

### Second Example Embodiment

As a second example embodiment of the present invention, the data collection system 1 will be described hereinafter in a more detailed manner.

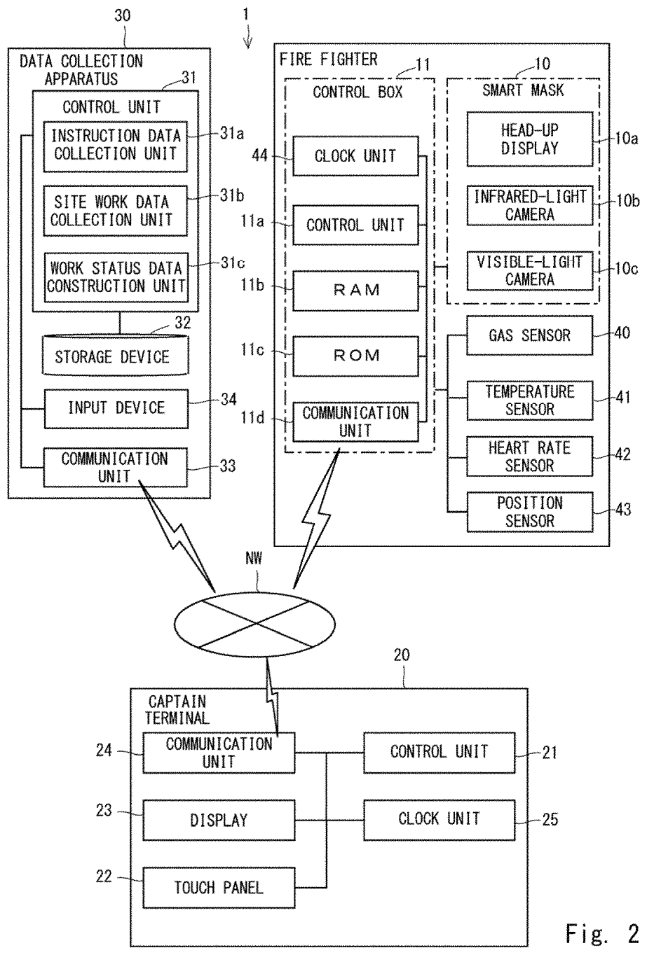

FIG. 2 is a detailed configuration diagram of the data collection system 1.

In the second example embodiment, an example in which: the leader is a leader of a fire brigade, the subordinates are members of the fire brigade; and the site is a fire site, will be described. Further, in the second example embodiment, as shown in FIG. 2, a captain terminal is used as the leader terminal 20. It will be referred to as a captain terminal 20 hereinafter. Further, a control BOX is used as the subordinate terminal 11. It will be referred to as a control BOX 11 hereinafter.

As shown in FIG. 2, the data collection system 1 includes a smart mask 10, a control BOX 11, a gas sensor 40, a temperature sensor 41, a heart rate sensor 42, a position sensor 43, a captain terminal 20, and a data collection apparatus 30.

Firstly, the configuration of the smart mask 10 will be described.

The smart mask 10 includes a mask (not shown) worn by a member of a fire brigade who works (i.e., is working) at a fire site, a head-up display 10a, an infrared-light camera 10b, and a visible-light camera 10c.

The head-up display 10a, the infrared-light camera 10b, and the visible-light camera 10c are attached to the mask.

The head-up display 10a is transparent, and various picture (virtual images) are displayed in a superimposed manner with the actual field of view of the member of the fire brigade wearing the smart mask 10 (the mask).

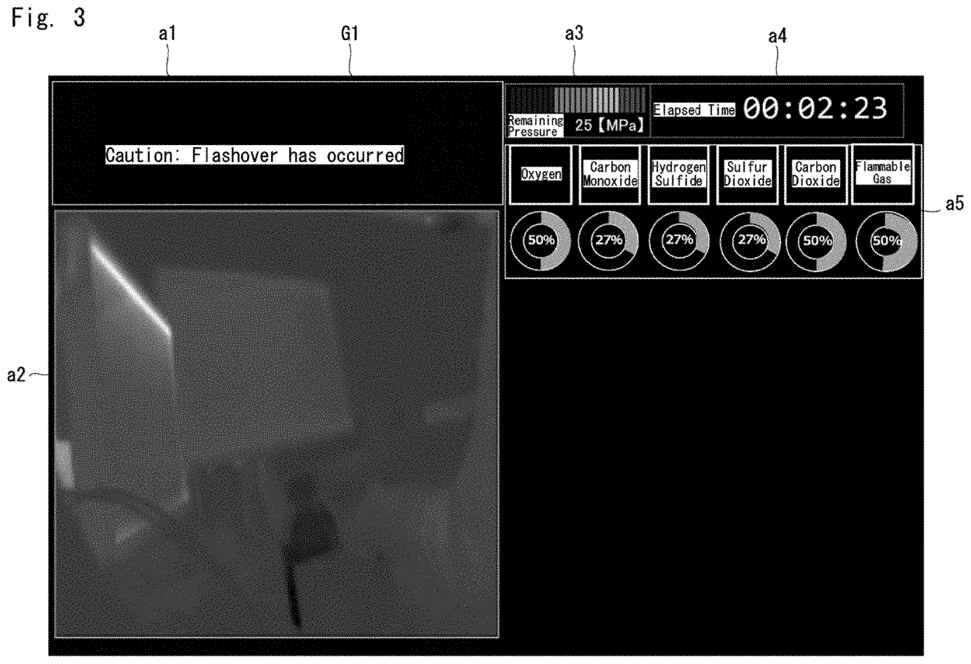

FIG. 3 shows an example of a picture G1 (e.g., a window G1) (a virtual image) displayed on the head-up display 10a.

As shown in FIG. 3, the picture G1 includes a remote support message display area a1, a camera image display area a2, an air cylinder remaining amount (remaining pressure) display area a3, an entry elapsed time display area a4, and a detection target gas concentration display area a5.

In the remote support message display area a1, various messages transmitted from the captain terminal 20 are displayed.

In the camera image display area a2, images (moving images or still images) taken by the infrared-light camera 10b or the visible-light camera 10c are displayed.

In the air cylinder remaining amount (remaining pressure) display area a3, the remaining amount (the remaining pressure) of an air cylinder equipped by the fire brigade is displayed.

In the entry elapsed time display area a4, the time that has elapsed after the member of the fire brigade entered the fire site is displayed.

In the detection target gas concentration display area a5, the concentrations of various gases, which are the results of the detection by the gas sensor(s) 40, are displayed.

The infrared-light camera 10b is an image-pickup apparatus that photographs (or films) the environment in which the members of the fire brigade work (i.e., are working), and is used when, for example, the environment in which the members of the fire brigade work is dark. The visible-light camera 10c is an image-pickup apparatus that photographs (or films) the environment in which the members of the fire brigade work, and is used when, for example, the environment in which the members of the fire brigade work is bright.

The gas sensor 40, the temperature sensor 41, the heart rate sensor 42, and the position sensor 43 are attached to an outfit (e.g., a fire suit) worn by the member of the fire brigade.

The gas sensor(s) 40 detects the concentration(s) of a gas(es) in the environment in which the members of the fire brigade work. The gas sensor 40 is, for example, an oxygen sensor for detecting the concentration of oxygen, a carbon monoxide sensor for detecting the concentration of carbon monoxide, a hydrogen sulfide sensor for detecting the concentration of hydrogen sulfide, a sulfur dioxide sensor for detecting the concentration of sulfur dioxide, and/or a flammable gas sensor for detecting the concentration of a flammable gas(es).

The temperature sensor 41 detects the temperature in the environment in which the members of the fire brigade work. The heart rate sensor 42 detects the heart rate of the member of the fire brigade. The position sensor 43 detects the position of the member of the fire brigade. As the position sensor 43, it is desirable to use, for example, a sensor capable of detecting the position of a member of a fire brigade without depending on the infrastructure.

Next, the configuration of the control BOX 11 will be described.

The control BOX 11 includes a control unit 11a, a RAM (Random Access Memory) 11b, a ROM (Read Only Memory) 11c, a communication unit lid, and a clock unit 44.

The control unit 11a includes a processor (not shown). The processor is, for example, a CPU (Central Processing Unit). The control unit 11a may include only one processor or may include a plurality of processors. The processor controls the smart mask 10 and the like by executing a certain program loaded from a nonvolatile memory such as the ROM 11c into the RAM 11b.

The communication unit 11d is a communication apparatus that wirelessly communicates with the captain terminal 20 and the data collection apparatus 30 through the communication line NW (e.g., the Internet).

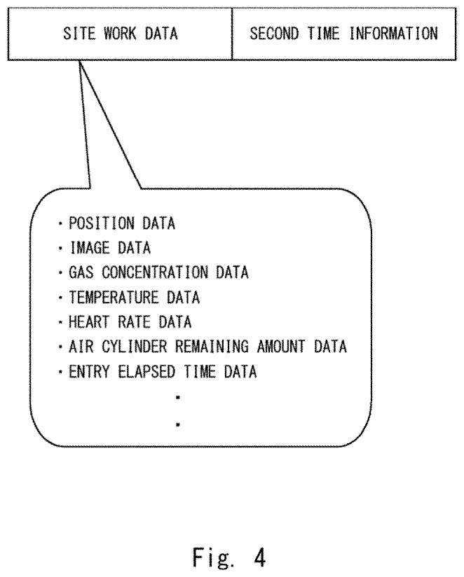

FIG. 4 shows an example of site work data and second time information indicating a time at which the site work data is detected (i.e., obtained) both of which the control BOX 11 (the communication unit 11d) transmits to the data collection apparatus 30.

The site work data is data representing work performed by the members of the fire brigade at the site, and is, for example, position data, image data, gas concentration data, temperature data, heart rate data, air cylinder remaining amount data, and/or entry elapsed time data as shown in FIG. 4.

The position data is data representing the position of the member of the fire brigade, detected by the position sensor 43. The image data is image data taken by the infrared-light camera 10b or the visible-light camera 10c. The gas concentration data is data representing the concentration(s) of a gas(es) detected by the gas sensor 40, and the temperature data is data representing a temperature detected by the temperature sensor 41. The heart rate data is data representing the heart rate of the member of the fire brigade detected by the heart rate sensor 42. The air cylinder remaining amount data is data representing the remaining amount (the remaining pressure) of an air cylinder, displayed in the air cylinder remaining amount (remaining pressure) display area a3 shown in FIG. 3. The entry elapsed time data is data representing an elapsed time, displayed in the entry elapsed time display area a4 shown in FIG. 3.

The second time information is, for example, a date and time that a clock unit 13 outputs at a timing at which site work data is detected.

Next, the configuration of the captain terminal 20 will be described.

The captain terminal 20 is, for example, a tablet-type information processing terminal, and as shown in FIG. 2, includes a control unit 21, a touch panel 22, a display 23, a communication unit 24, and a clock unit 25.

The control unit 21 includes a processor (not shown). The processor is, for example, a CPU. The control unit 21 may include only one processor or may include a plurality of processors. The processor controls the display 23 and the like by executing a certain program loaded from a nonvolatile memory such as a ROM (not shown) into a RAM (not shown).

The touch panel 22 is an input device operated by the leader of the fire brigade, and is disposed so as to cover the display surface of the display 23. The display 23 is, for example, a display equipped with the touch panel 22. A display equipped with a touch panel is also called a touch screen display.

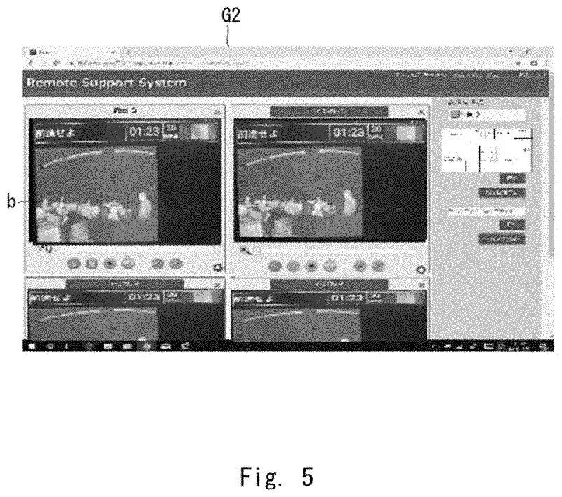

FIG. 5 shows an example of a picture G2 (e.g., a window G2) displayed on the display 23.

As shown in FIG. 5, the picture G2 includes a camera image display area b.

In the camera image display area b, the same images (the same moving images or the same still images) as those displayed on the head-up display 10a of the smart mask 10 worn by the member of the fire brigade are displayed.

The communication unit 24 is a communication apparatus that wirelessly communicates with the control BOX 11 and the data collection apparatus 30 through the communication line NW (e.g., the Internet).

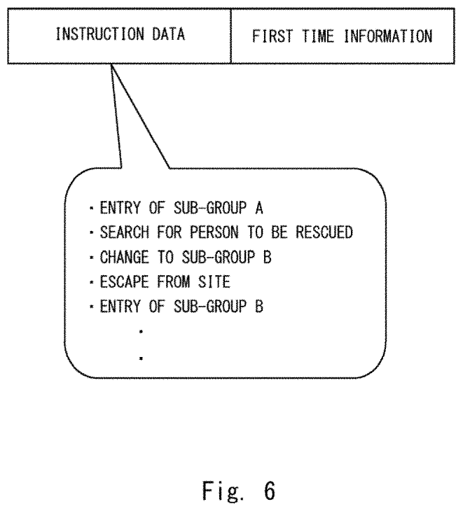

FIG. 6 shows an example of instruction data and first time information indicating a time at which the instruction data was output both of which the captain terminal 20 (the communication unit 24) transmits to the data collection apparatus 30.

The instruction data is data representing an instruction that the leader of the fire brigade has given to the members of the fire brigade, and is input as the leader of the fire brigade operates the touch panel 22. As shown in FIG. 6, the instruction data is, for example, “Entry of Sub-group A”, “Search for Person to be Rescued”, “Change to Sub-group B”, “Escape from Site”, or “Entry of Sub-group B”. The instruction data may be a fixed phrase or input text.

The first time information is, for example, a date and time that is output from the clock unit 25 at a timing at which the leader of the fire brigade gave an instruction (i.e., at which the leader of the fire brigade input instruction data).

Next, the configuration of the data collection apparatus 30 will be described.

The data collection apparatus 30 is installed at a place remote from the fire site (e.g., at a fire command central). As shown in FIG. 2, the data collection apparatus 30 includes a control unit 31, a storage device 32, a communication unit 33, and an input device 34.

The control unit 31 includes a processor (not shown). The processor is, for example, a CPU. The control unit 31 may include only one processor or may include a plurality of processors. The processor functions as an instruction data collection unit 31a, a site work data collection unit 31b, and a work status data construction unit 31c by executing a certain program loaded from a nonvolatile memory such as a ROM (not shown) into a RAM (not shown).

The instruction data collection unit 31a collects instruction data and first time information (See FIG. 6) transmitted from the captain terminal 20 (the communication unit 24). The instruction data collection unit 31a is an example of the instruction data collection means according to the present invention.

The site work data collection unit 31b collects site work data and second time information (See FIG. 4) transmitted from the control BOX 11 (the communication unit 11d). The site work data collection unit 31b is an example of the site work data collection means according to the present invention.

The work status data construction unit 31c constructs first work status data that is obtained by rearranging the site work data and the instruction data accumulated in the storage device 32 in a chronological order. Further, when at least one of the site work data and the instruction data is edited through the input device 34, the work status data construction unit 31c constructs second work status data that is obtained by rearranging the site work data and the instruction data including the edited site work data and the edited instruction data in a chronological order. The work status data construction unit 31c is an example of the work status data construction means according to the present invention.

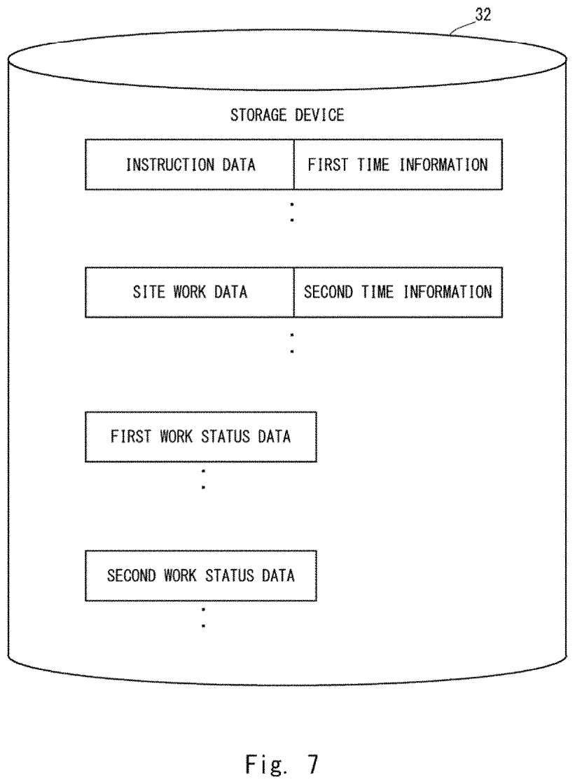

FIG. 7 shows an example of various data stored (accumulated) in the storage device 32.

As shown in FIG. 7, in the storage device 32, instruction data and first time information collected by the instruction data collection unit 31a, and site work data and second time information collected by the site work data collection unit 31b are accumulated. Further, in the storage device 32, the first work status data and the second work status data constructed by the work status data construction unit 31c are stored.

The communication unit 33 is a communication apparatus that wirelessly communicates with the control BOX 11 and the captain terminal 20 through the communication line NW (e.g., the Internet).

The input device 34 is, for example, a keyboard or a mouse. The input device 34 is used to edit at least one of the site work data (including the second time information) and the instruction data (including the first time information) stored in the storage device 32. The input device 34 is an example of the editing means according to the present invention.

Next, as an example of operations performed by the data collection system 1 having the above-described configuration, a site work data collection process will be described.

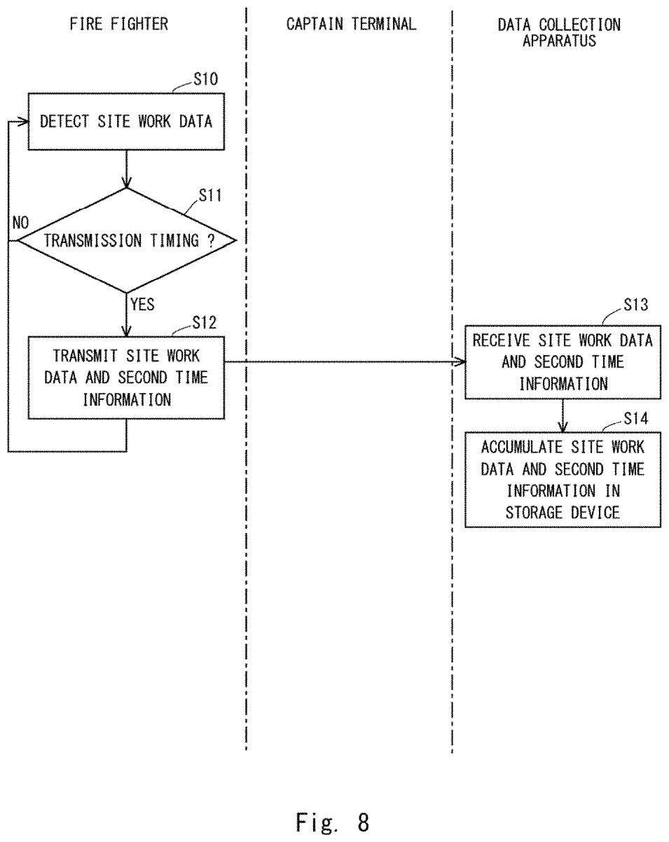

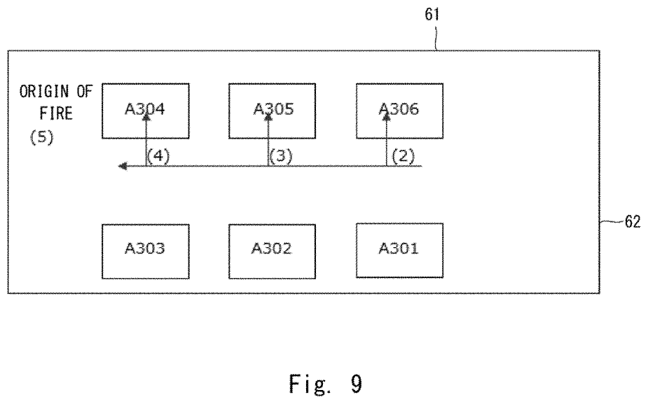

FIG. 8 is a sequence diagram of operations (the site work data collection process) performed by the data collection system 1. FIG. 9 shows an example of a site (a fire site) where members of the fire brigade work.

In the following description, it is assumed that the picture G1 shown in FIG. 2 is displayed on the head-up display 10a worn by the member of the fire brigade. Further, as shown in FIG. 9, it is assumed that a building 61 at the fire site has rooms A301 to A306 on the same floor, and members of the fire brigade enter the building 61 through an emergency exit 62 and move in the order of arrows (2), (3), (4) and (5).

Firstly, various sensors detect (i.e., obtain) site work data (Step S10).

For example, the infrared-light camera 10b photographs (or films) the environment in which the members of the fire brigade work. Further, the gas sensor 40 detects the concentration(s) of a gas(es) in the environment in which the members of the fire brigade work. Further, the temperature sensor 41 detects the temperature in the environment in which the members of the fire brigade work. Further, the heart rate sensor 42 detects the heart rate of the member of the fire brigade. Further, the position sensor 43 detects the position of the member of the fire brigade.

Next, every time a predetermined transmission timing comes (Step S11: Yes), e.g., every time a predetermined time (e.g., 5 minutes) has elapsed, the control BOX 11 (the communication unit 11d) transmits the site work data detected in the step S10 and the second time information output by the clock unit 44 (See FIG. 4) to the data collection apparatus 30 through the communication line NW while associating them with each other (Step S12).

Next, the data collection apparatus 30 (the communication unit 33) receives the site work data and the second time information transmitted from the control BOX 11 (Step S13).

Next, the data collection apparatus 30 (the site work data collection unit 31b) accumulates the site work data and the second time information received from the control BOX 11 in the storage device 32 while associating them with each other (Step S14, See FIG. 7).

The above-described processes in the processing steps S10 to S14 are repeatedly performed while the member(s) of the fire brigade enters the building 61 and moves in the order of arrows (2), (3), (4) and (5).

Next, as an example of operations performed by the data collection system 1 having the above-described configuration, an instruction data collection process will be described.

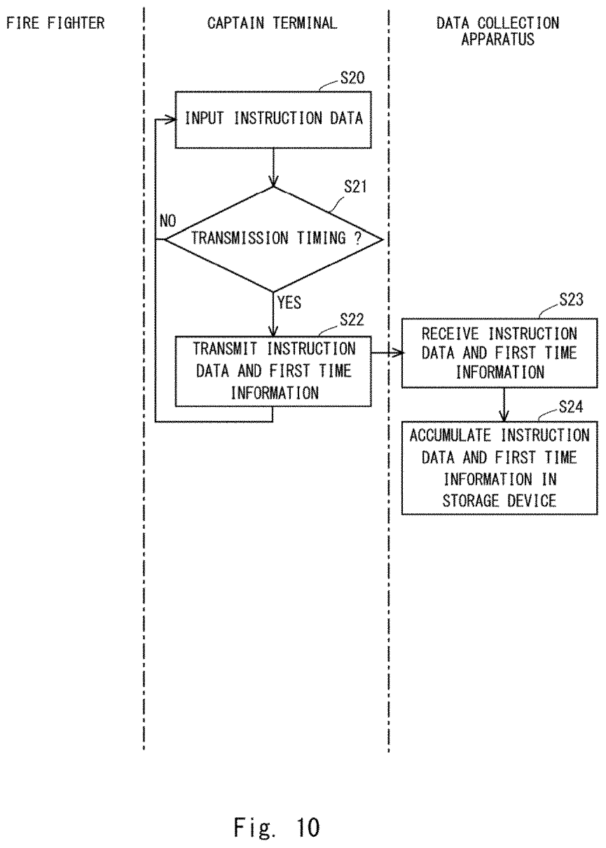

FIG. 10 is a sequence diagram of operations (the instruction data collection process) performed by the data collection system 1.

Firstly, the leader of the fire brigade inputs (i.e., enters) instruction data through the touch panel 22 (Step S20).

Next, every time a predetermined transmission timing comes (Step S21: Yes), e.g., every time a predetermined time (e.g., 5 minutes) has elapsed, the captain terminal 20 (the communication unit 24) transmits the instruction data input in the step S20 and the first time information output by the clock unit 25 (See FIG. 6) to the data collection apparatus 30 through the communication line NW while associating them with each other (Step S22).

Next, the data collection apparatus 30 (the communication unit 33) receives the instruction data and the first time information transmitted from the captain terminal 20 (the communication unit 24) (Step S23).

Next, the data collection apparatus 30 (the instruction data collection unit 31a) accumulates the instruction data the first time information received from the captain terminal 20 (the communication unit 24) in the storage device 32 while associating them with each other (Step S24) (See FIG. 7).

The above-described processes in the processing steps S20 to S24 are repeatedly performed while the member of the fire brigade enters the building 61 and moves in the order of arrows (2), (3), (4) and (5).

Next, as an example of operations performed by the data collection system 1 having the above-described configuration, a work status data construction process 1 will be described.

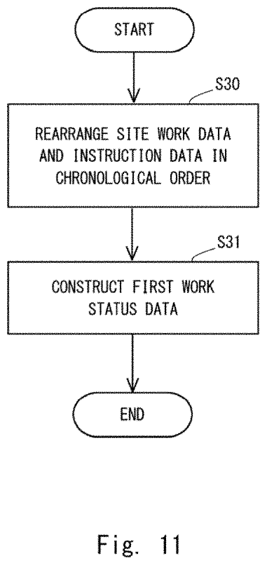

FIG. 11 is a flowchart of operations (the work status data construction processing 1) performed by the data collection system 1. The processes shown in FIG. 11 are performed by the data collection apparatus 30 when, for example, an operator provides an instruction for constructing work status data through the input device 34.

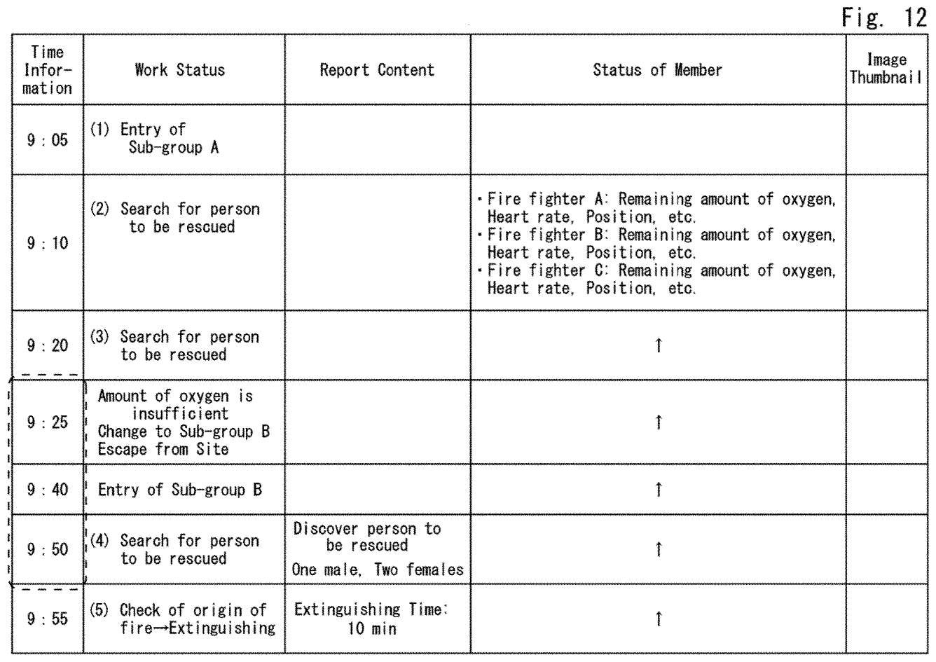

When the operator provides the instruction for constructing the work status data through the input device 34, the data collection apparatus 30 (the work status data construction unit 31c) rearranges the site work data and the instruction data accumulated in the storage device 32 in a chronological order based on the first and second time information stored in the storage device 32 (Step S30). In this way, first work status data in which the site work data and the instruction data are rearranged in a chronological order is constructed (created) (Step S31). FIG. 12 is an example of the first work status data. The constructed first work status data is stored, for example, in a file format in the storage device 32 (See FIG. 7). “Time Information” in FIG. 12 corresponds to the first and second time information. “Working Status” corresponds to the instruction data. “Report Content”, “Status of Member” and “Image Thumbnail” correspond to the site work data.

The first site work data constructed as described above can be displayed on a display or printed and distributed. This makes it possible for multiple people to share information and perform review (e.g., a review of when and what actions were taken at the site and their appropriateness) of site activities.

For example, in the case of the first site work data shown in FIG. 12, a portion surrounded by a dotted line in FIG. 12 is referred to. This makes it possible to review as follows. “If the trained firefighters had the remaining oxygen, the 25 minutes between taking turns and finding the person in need of rescue could be shortened, and rescue operations could be carried out more quickly.”

Next, as an example of operations performed by the data collection system 1 having the above-described configuration, a work status data construction process 2 will be described.

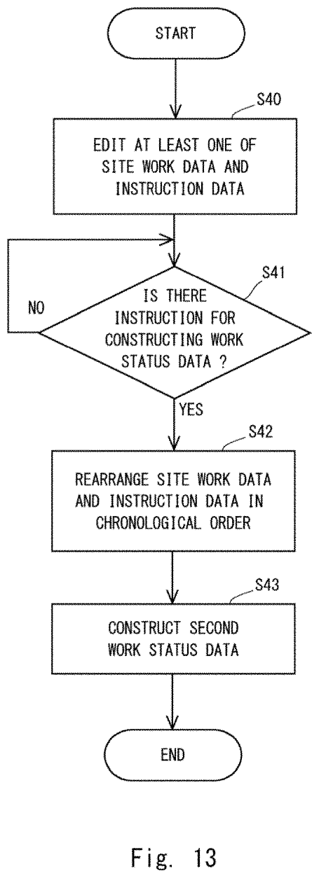

FIG. 13 is a flowchart of operations (the work status data construction process 2) performed by the data collection system 1. The processes shown in FIG. 13 are performed by the data collection apparatus 30.

Firstly, an operator (e.g., a skilled member of a fire brigade) edits at least one of the site work data (including the second time information) and the instruction data (including the first time information) stored in the storage device 32 through the input device 34 (Step S40). For example, the skilled member of the fire brigade edits a part(s) of the site work data (the including second time information) and the instruction data (including the first time information) that he or she thinks it is desirable to work in a way he or she desires based on his or her knowledge and experiences.

Next, when the operator provides an instruction for constructing work status data through the input device 34 (Step S41: Yes), the data collection apparatus 30 (the work status data construction unit 31c) rearranges the site work data and the instruction data including the site work data and the instruction data edited in the step S40 in a chronological order based on the first time information and the second time information stored in the storage device 32 (Step S42). In this way, second work status data in which the site work data and the instruction data including the site work data and the instruction data edited in the step S40 are rearranged are constructed (created) (Step S43). The constructed second work status data is stored, for example, in a file format in the storage device 32 (See FIG. 7).

The second site work data constructed as described above becomes one in which knowledge and experiences of a skilled member of a fire brigade are taken into consideration in the first site work data. Therefore, for example, it is possible to display the first and second site work data in a comparing manner on a display, or print and distribute them, and thereby to present the fastest pattern (or the optimal pattern) of the rescue operation. Further, it is possible to clarify the difference between the fastest pattern and the actual work pattern. Further, it is possible to plan a strategy for the next rescue operation while taking the difference into consideration. Further, a plurality of people can share the information and reflect on the work performed at the site (e.g., reflect on when they took actions and what kind of actions they took at the site, and whether or not, for example, the actions were appropriate as compared to those performed by a skilled member of a fire brigade).

Next, as an example of operations performed by the data collection system 1 having the above-described configuration, a work status data output process will be described.

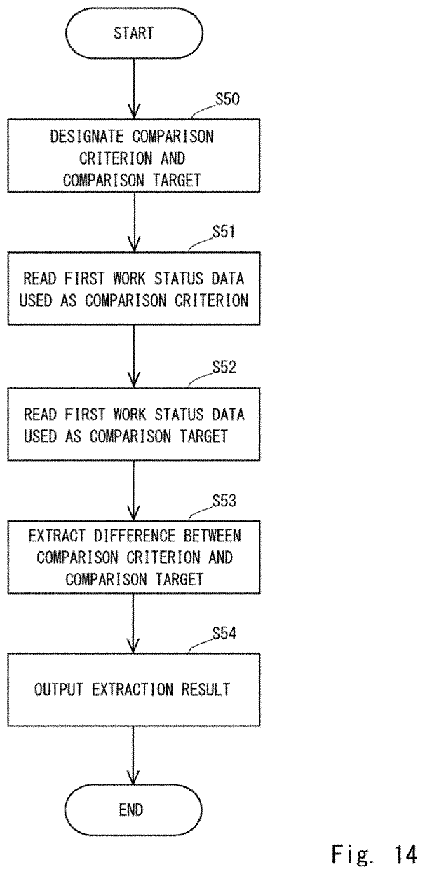

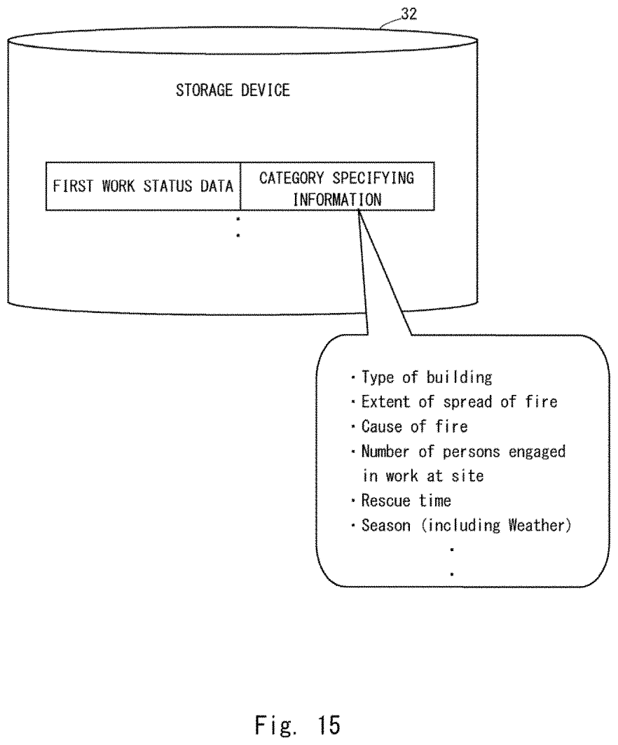

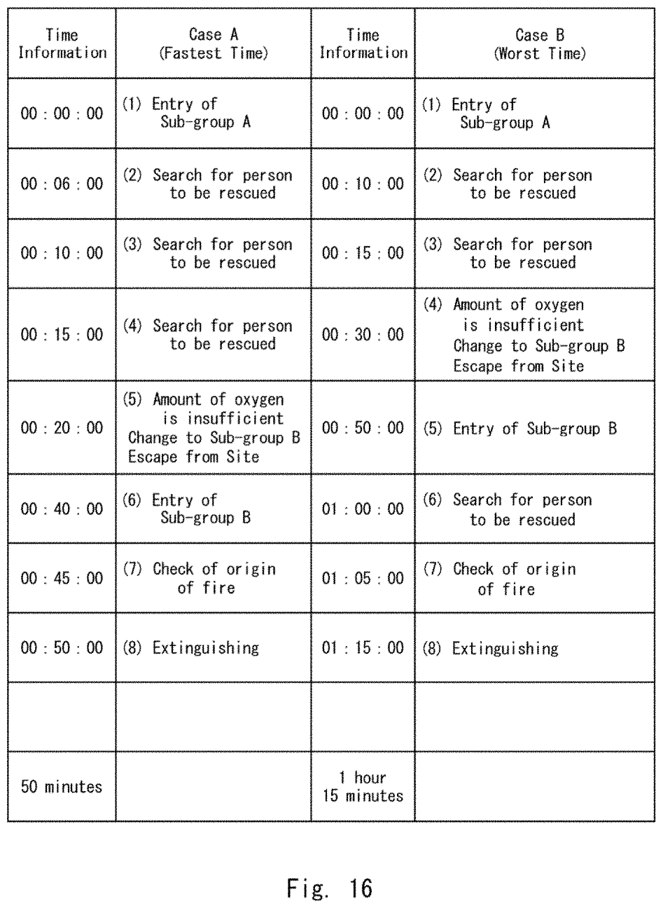

FIG. 14 is a flowchart of operations (the work status data output process) performed by the data collection system 1. FIG. 15 is an example of a plurality of first work status data stored in the storage device 32. FIG. 16 is a specific example of a plurality of first work status data stored in the storage device 32. The processes shown in FIG. 14 are performed by the data collection apparatus 30 when, for example, an operator provides an instruction for the work status data output process through the input device 34.

In the following description, as shown in FIG. 15, it is assumed that a plurality of first work status data (a plurality of first work status data of different sites) are accumulated in the storage device 32. Each of the first work status data is constructed by, for example, the above-described work status data construction process 1. Further, each of the first work status data is stored in association with category specifying information.

The category specifying information includes, for example, a type of building (e.g., a building housing a number of independent business concerns, a large warehouse, or a detached houses), the extent of spread of fire, the cause of fire, the number of persons engaged in work at the site, a rescue time, and a season (including weather). The category specifying information may be input through the input device 34 or may be received from the control BOX 11.

Firstly, an operator designates, through the input device 34, first work status data used as a comparison criterion and first work status data used as a comparison target (Step S50). For example, to reflect on the work or the like, the operator designates first work status data which is in the same or a similar category and of which the rescue time is the fastest as the comparison criterion, and designates first work status data of the current rescue operation (i.e., the rescue operation of interest) as the comparison target (the work which should be reflected on).

Here, it is assumed that the first work status data shown on the left side in FIG. 16 (Case A) is designated as the first work status data used as the comparison criterion, and the first work status data shown on the right side in FIG. 16 (Case B) is designated as the first work status data used as the comparison target. The Case A is work performed by a skilled member of a fire brigade, and its rescue operation took 50 minutes. Meanwhile, the Case B is work performed by an inexperienced member of a fire brigade, and its rescue operation took 1 hour and 15 minutes.

Next, the data collection apparatus 30 (e.g., the control unit 31) reads the first work status data used as the comparison criterion designated in the step S50 from the storage device 32 (Step S51).

Next, the data collection apparatus 30 (e.g., the control unit 31) reads the first work status data used as the comparison target designated in the step S50 from the storage device 32 (Step S52). For example, the data collection apparatus 30 (e.g., the control unit 31) reads, among the first work status data with which the same category specifying information as or a category specifying information similar to the category specifying information associated with the first work status data used as the comparison criterion designated in the step S50 is associated, first work status data of which the rescue time is the fastest from the storage device 32.

Here, it is assumed that the first work status data shown on the left side in FIG. 16 (Case A) is read as the first work status data used as the comparison criterion. Further, it is assumed that the first work status data shown on the right side in FIG. 16 (Case B) is read as the first work status data used as the comparison target.

Next, the data collection apparatus 30 (e.g., the control unit 31) compares the first work status data used as the comparison criterion read in the step S51 with the first work status data used as the comparison target read in the step S52, and thereby extracts a difference between them (Step S53).

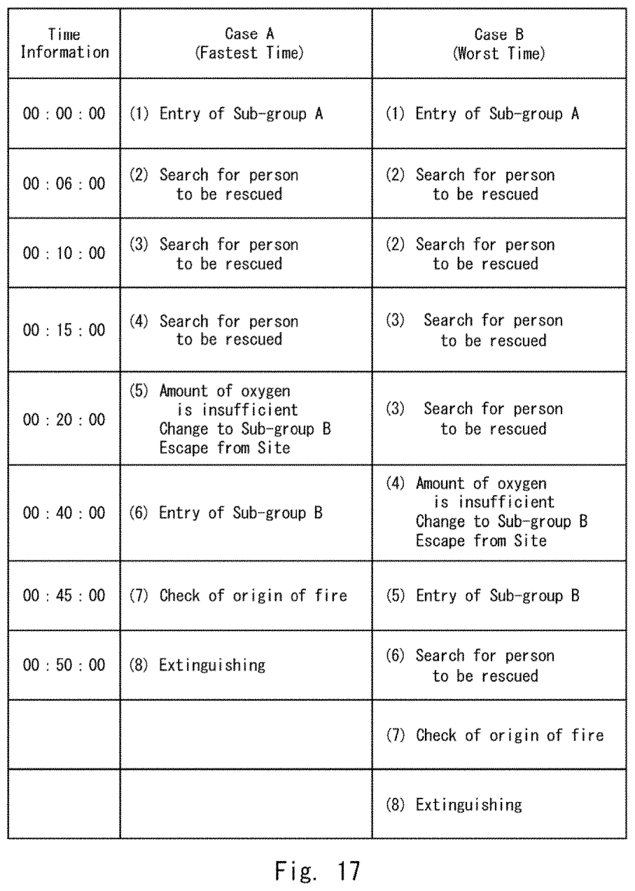

When doing so, the data collection apparatus 30 (e.g., the control unit 31) compares them at each of times contained in the first work status data used as the comparison criterion (in this example, the Case A). FIG. 17 shows an example in which, for each of times contained in the first work status data used as the comparison criterion (in this example, the Case A), the work in the first work status data used as the comparison criterion (in this example, the Case A) at that time is compared with the work in the first work status data used as the comparison target (in this example, the Case B) at that time. “Time Information” and “Case A ” in FIG. 17 are the same as “Time Information” and “Case A” on the left side in FIG. 16. “Case B ” in FIG. 17 is work in the first work status data used as the comparison target (in this example, the Case B) (See FIG. 16) at the time indicated by “Time Information” shown in FIG. 17.

In the step S53, in the case of FIG. 17, “(7) Checking of Origin of Fire” and “(8) Extinguishing” in the Case B, which are work performed after “Time Information” 00:50:00 (a rescue operation completion time) in the Case A, are extracted as the difference.

Next, the data collection apparatus 30 (e.g., the control unit 31) outputs the extraction result obtained in the step S53 (Step S54). For example, the extraction result obtained in the step S53 is displayed on a display (not shown) or printed by a printer (not shown). Note that the data collection apparatus 30 may output, instead of outputting only the extraction result, the whole comparison result shown in FIG. 17 including the extraction result.

In such a case, the data collection apparatus 30 may output the extraction result (e.g., “(7) Checking of Origin of Fire” and “(8) Extinguishing” in the Case B shown in FIG. 17) while emphasizing it in a different color (e.g., blue). Further, the data collection apparatus 30 may output, among the work in the first work status data used as the comparison target (in this example, the Case B), the same work as that in the first work status data used as the comparison criterion (in this example, the Case A) (e.g., “(2) Search for Person to be Rescued” and “(3) Search for Person to be Rescued” in the Case B shown in FIG. 17) while emphasizing it in a different color (e.g., red). By doing so, for example, it is possible, at a glance, to compare an operation in the first work status data used as the comparison target (in this example, the Case B) with one operation in the first work status data used as the comparison criterion (in this example, the Case A), and understand them. For example, in the case of the example shown in FIG. 17, in the Case A, “(2) Search for Person to be Rescued” was started at “Time Information” 00:06:00 and the next “(3) Search for Person to be Rescued” was started four minutes later. In contrast, in the Case B, the same operation as “(2) Search for Person to be Rescued” in the Case A, i.e., “(2) Search for Person to be Rescued” was continued for nine minutes.

Further, image thumbnails (not shown) may be displayed for respective items shown in FIG. 17, so that the operator can select an image thumbnail from among them through the input device 34 and display a corresponding image. For example, an image thumbnail may be displayed on the right side of “(7) Checking of Origin of Fire” in the Case B, and the operator may select this image thumbnail through the input device 34 and thereby display an image at the time of the checking of the origin of fire. The same applies to the other items in the Cases A and B other than “(7) Checking of Origin of Fire” in the Case B.

By outputting the extraction result obtained in the step S53 as described above, it is possible to automatically extract information as to what kind of action during the work was the “key” to the reduction in time, and feed back the extracted information for the next site work (e.g., for work at the next site). Further, in the case of the example shown in FIG. 16, it is possible to understand that the search for a person(s) to be rescued at the site was able to be performed 25 minutes quicker in the Case A than in the Case B because the member of the fire brigade who entered the site in the Case A was more skilled and consumed less oxygen than in the Case B. Further, it is possible to analyze, examine, and provide feedback as to why the rescue operation in the Case A was shorter than that in the Case B, in which the environment was similar to that in the Case A, by 25 minutes.

Further, it is also possible to clarify the difference between a case which is in the same or a similar category and of which the rescue time is the fastest (e.g., the Case A) and an actual case (e.g., the Case B). Further, it is possible to plan a strategy for the next rescue operation while taking the difference into consideration. Further, a plurality of people can share the information and reflect on the work performed at the site (e.g., reflect on when they took actions and what kind of actions they took at the site, and whether or not, for example, the actions were appropriate as compared to those performed by a skilled member of a fire brigade).

Further, it is possible to understand that the rescue time changes due to the difference in the skill of the member of the fire brigade.

As described above, by outputting the extraction result obtained in the step S53, it is possible to reflect on the work and the like in order to use the extraction result in the next site work. As a result, it is possible to use the extraction result to protect the lives of members of the fire brigade and the lives of persons to be rescued in the next site work. For example, it is possible to understand that, under the condition of the “neutral zone” that occurs in the early stage of fire, an inexperienced member of a fire brigade sprayed water, so that the “neutral zone” was disrupted and a high-temperature layer descended and spread, leading to the injury of the member of the fire brigade and the injury of a person(s) to be rescued, and to the delay of the rescue operation. Therefore, by taking this recognition into consideration, it is possible to use it to protect the lives of members of a fire brigade and the lives of persons to be rescued in the next site work.

As described above, according to the second example embodiment, it is possible to enable a leader (e.g., a leader of a fire brigade), who leads subordinates (e.g., members of the fire brigade) who are working at a site (e.g., a fire site), to collect and accumulate instruction data representing an instruction that the leader has given to the subordinates and site work data representing work (e.g., activities) that has been performed by the subordinates in response to the instruction. The above-described accumulated site work data can be used in a variety of ways after they leave the site. For example, by the site work data, the work status including those shown in images can be understanded in a chronological order, so that it can be used when they reflect on the work performed at the site (e.g., when they reflect on when they took actions and what kind of actions they took at the site, and whether or not the timing and the actions were appropriate).

Next, modified examples will be described.

In the above-described second example embodiment, an example in which the leader is a leader of a fire brigade and the subordinate(s) is a member(s) of a fire brigade has been described, but the present invention is not limited this example. For example, the leader may be a person who gives instructions in the police or in the Self-Defense Forces, and the subordinate(s) may one (those) who works according to the instructions.

In the above-described first and second example embodiments, the program may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), CD-R, CD-R/W, and a semiconductor memory (such as a mask ROM, a PROM (Programmable ROM), an EPROM (Erasable PROM), a flash ROM, and a RAM (Random Access Memory)). Further, the programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line (e.g., electric wires and optical fibers) or a radio communication line.

All the numeral values mentioned in the above-described example embodiments are merely examples, and needless to say, numeral values different from them can be uses as desired.

The above-described example embodiments are merely examples in all the aspects thereof. The present invention should not be limited by the descriptions of the above-described example embodiments. The present invention may be carried out in various other forms without departing from the spirit or main features of the invention.

Further, the whole or part of the example embodiments disclosed above can be described as, but not limited to, the following supplementary notes.

### (Supplementary Note 1)

A data collection apparatus comprising:

instruction data collection means for collecting instruction data representing an instruction that a leader has given to a subordinate, and first time information indicating a time at which the instruction was given, the subordinate being a person who works at a site, the leader being a person who leads the subordinate, and the instruction data and the first time information being data and information transmitted from a leader terminal operated by the leader;

site work data collection means for collecting site work data representing work performed by the subordinate at the site, and second time information indicating a time at which the site work data was detected, the site work data and the second time information being data and information transmitted from a subordinate terminal carried by the subordinate; and

a storage device in which the instruction data and the first time information collected by the instruction data collection means, and the site work data and the second time information collected by the site work data collection means are accumulated.

### (Supplementary Note 2)

The data collection apparatus described in Supplementary note 1, wherein the site work data includes position data representing a position of the subordinate.

### (Supplementary Note 3)

The data collection apparatus described in Supplementary note 1, further comprising work status data construction means, wherein

the work status data construction means constructs first work status data that is obtained by rearranging the site work data and the instruction data stored in the storage device in a chronological order.

### (Supplementary Note 4)

The data collection apparatus described in Supplementary note 3, wherein the instruction data and the site work data representing work performed according to an instruction represented by the instruction data are stored in the storage device in a state in which they are associated with each other.

### (Supplementary Note 5)

The data collection apparatus described in Supplementary note 3 or 4, further comprising editing means for editing at least one of the site work data and the instruction data stored in the storage device, wherein

the work status data construction means constructs second work status data that is obtained by rearranging the site work data and the instruction data including the site work data and the instruction data edited by the editing means, which are stored in the storage device, in a chronological order.

### (Supplementary Note 6)

The data collection apparatus described in any one of Supplementary notes 1 to 5, further comprising:

first reading means for reading first work status data used as a comparison criterion from the storage device;

second reading means for reading first work status data used as a comparison target from the storage device;

difference extraction means for comparing the first work status data used as the comparison criterion read by the first reading means with the first work status data used as the comparison target read by the second reading means, and thereby extracting a difference therebetween; and

output means for outputting a result of the extraction by the difference extraction means.

### (Supplementary Note 7)

The data collection apparatus described in Supplementary note 6, wherein the first work status data used as the comparison target belongs to the same category as that of the first work status data used as the comparison criterion.

### (Supplementary Note 8)

The data collection apparatus described in Supplementary note 6 or 7, wherein the output means further outputs, for each of times contained in the first work status data used as the comparison criterion, work in the first work status data used as the comparison criterion at that time and work in the first work status data used as the comparison target at that time.

### (Supplementary Note 9)

The data collection apparatus described in Supplementary note 8, wherein the output means further outputs, among the work in the first work status data used as the comparison target, the same work as that in the first work status data used as the comparison criterion in an emphasized manner.

### (Supplementary Note 10)

A data collection system comprising:

a leader terminal operated by a leader, the leader being a person who leads a subordinate who works at a site;

a subordinate terminal carried by the subordinate; and

a data collection apparatus, wherein

the data collection apparatus includes:

instruction data collection means for collecting instruction data representing an instruction that the leader has given to the subordinate, and first time information indicating a time at which the instruction was given, the instruction data and the first time information being data and information transmitted from the leader terminal operated by the leader;

site work data collection means for collecting site work data representing work performed by the subordinate at the site, and second time information indicating a time at which the site work data was detected, the site work data and the second time information being data and information transmitted from the subordinate terminal carried by the subordinate; and

a storage device in which the instruction data and the first time information collected by the instruction data collection means, and the site work data and the second time information collected by the site work data collection means are accumulated.

### (Supplementary Note 11)

The data collection system described in Supplementary note 10, wherein the site work data includes subordinate position data representing a position of work performed by the subordinate.

### (Supplementary Note 12)

A data collection method comprising:

a step of collecting instruction data representing an instruction that a leader has given to a subordinate, and first time information indicating a time at which the instruction was given, the subordinate being a person who works at a site, the leader being a person who leads the subordinate, and the instruction data and the first time information being data and information transmitted from a leader terminal operated by the leader;

a step of collecting site work data representing work performed by the subordinate at the site, and second time information indicating a time at which the site work data was detected, the site work data and the second time information being data and information transmitted from a subordinate terminal carried by the subordinate; and

a step of accumulating the collected instruction data and the first time information, and the collected site work data and the second time information in a storage device.

### (Supplementary Note 13)

The data collection method described in Supplementary note 12, further comprising a step of constructing first work status data that is obtained by rearranging the site work data and the instruction data stored in the storage device in a chronological order.

### (Supplementary Note 1)

A computer readable recording medium storing a program for causing an electronic device including at least one processor to perform:

a process for collecting instruction data representing an instruction that a leader has given to a subordinate, and first time information indicating a time at which the instruction was given, the subordinate being a person who works at a site, the leader being a person who leads the subordinate, and the instruction data and the first time information being data and information transmitted from a leader terminal operated by the leader;

a process for collecting site work data representing work performed by the subordinate at the site, and second time information indicating a time at which the site work data was detected, the site work data and the second time information being data and information transmitted from a subordinate terminal carried by the subordinate; and

a process for accumulating the collected instruction data and the first time information, and the collected site work data and the second time information in a storage device.

### (Supplementary Note 15)

The computer readable recording medium described in Supplementary note 14, further storing a program for causing the electronic device to perform a process for constructing first work status data that is obtained by rearranging the site work data and the instruction data stored in the storage device in a chronological order.

### REFERENCE SIGNS LIST

1 DATA COLLECTION SYSTEM
10 SMART MASK
10a HEAD-UP DISPLAY
10b INFRARED-LIGHT CAMERA
10c VISIBLE-LIGHT CAMERA
11 SUBORDINATE TERMINAL (CONTROL BOX)
11a CONTROL UNIT
11d COMMUNICATION UNIT
20 LEADER TERMINAL (TEAM LEADER TERMINAL)
21 CONTROL UNIT
22 TOUCH PANEL
23 DISPLAY
24 COMMUNICATION UNIT
25 CLOCK UNIT
30 DATA COLLECTION APPARATUS
31 CONTROL UNIT
31a INSTRUCTION DATA COLLECTION UNIT
31b SITE WORKING DATA COLLECTION UNIT
31c WORKING STATUS DATA CONSTRUCTION UNIT
32 STORAGE DEVICE
33 COMMUNICATION UNIT
34 INPUT DEVICE
40 GAS SENSOR
41 TEMPERATURE SENSOR
42 HEART RATE SENSOR
43 POSITION SENSOR
44 CLOCK UNIT
61 BUILDING
a2 CAMERA IMAGE DISPLAY AREA
a3 AIR CYLINDER REMAINING AMOUNT (REMAINING PRESSURE) DISPLAY AREA
a4 ENTRY ELAPSED TIME DISPLAY AREA
a5 DETECTION TARGET GAS CONCENTRATION DISPLAY AREA
b CAMERA IMAGE DISPLAY AREA
NW COMMUNICATION LINE

What is claimed is:

1. A data collection apparatus comprising:
at least one memory configured to store one or more instructions; and
at least one processor configured to execute the one or more instructions to:
collect instruction data representing an instruction that a leader has given to a subordinate, and first time information indicating a time at which the instruction was given, the subordinate being a person who works at a site, the leader being a person who leads the subordinate, and the instruction data and the first time information being data and information transmitted from a leader terminal operated by the leader;
collect site work data representing work performed by the subordinate at the site, and second time information indicating a time at which the site work data was detected, the site work data and the second time information being data and information transmitted from a subordinate terminal carried by the subordinate; and
a storage device in which the instruction data and the first time information collected, and the site work data and the second time information collected are accumulated.

2. The data collection apparatus according to claim 1, wherein the site work data includes position data representing a position of the subordinate.

3. The data collection apparatus according to claim 1, wherein the at least one processor is further configured to execute the instructions to
construct first work status data that is obtained by rearranging the site work data and the instruction data stored in the storage device in a chronological order.

4. the data collection apparatus according to claim 3, wherein the instruction data and the site work data representing work performed according to an instruction represented by the instruction data are stored in the storage device in a state in which they are associated with each other.

5. The data collection apparatus according to claim 3, wherein the at least one processor is further configured to execute the instructions to edit at least one of the site work data and the instruction data stored in the storage device, wherein
the at least one processor is further configured to execute the instructions to construct second work status data that is obtained by rearranging the site work data and the instruction data including the site work data and the instruction data edited, which are stored in the storage device, in a chronological order.

6. The data collection apparatus according to claim 1, wherein the at least one processor is further configured to execute the instructions to
read first work status data used as a comparison criterion from the storage device;
read first work status data used as a comparison target from the storage device;
compare the first work status data used as the comparison criterion read with the first work status data used as the comparison target read, and thereby extracting a difference therebetween; and
output a result of the extraction.

7. The data collection apparatus according to claim 6, wherein the first work status data used as the comparison target belongs to the same category as that of the first work status data used as the comparison criterion.

8. the data collection apparatus according to claim 6, wherein the at least one processor is further configured to execute the instructions to output, for each of times contained in the first work status data used as the comparison criterion, work in the first work status data used as the comparison criterion at that time and work in the first work status data used as the comparison target at that time.

9. The data collection apparatus according to claim 8, wherein the at least one processor is further configured to execute the instructions to output, among the work in the first work status data used as the comparison target, the same work as that in the first work status data used as the comparison criterion in an emphasized manner.

10. A data collection system comprising:
a leader terminal operated by a leader, the leader being a person who leads a subordinate who works at a site;
a subordinate terminal carried by the subordinate; and
a data collection apparatus, wherein
the data collection apparatus includes:
at least one memory configured to store one or more instructions; and
at least one processor configured to execute the one or more instructions to:
collect instruction data representing an instruction that the leader has given to the subordinate, and first time information indicating a time at which the instruction was given, the instruction data and the first time information being data and information transmitted from the leader terminal operated by the leader;
collect site work data representing work performed by the subordinate at the site, and second time information indicating a time at which the site work data was detected, the site work data and the second time information being data and information transmitted from the subordinate terminal carried by the subordinate; and
a storage device in which the instruction data and the first time information collected, and the site work data and information collected are accumulated.

11. The data collection system according to claim 10, wherein the site work data includes subordinate position data representing a position of work performed by the subordinate.

12. A data collection method comprising:
a step of collecting instruction data representing an instruction that a leader has given to a subordinate, and first time information indicating a time at which the instruction was given, the subordinate being a person who works at a site, the leader being a person who leads the subordinate, and the instruction data and the first time information being data and information transmitted from a leader terminal operated by the leader;
a step of collecting site work data representing work performed by the subordinate at the site, and second time information indicating a time at which the site work data was detected, the site work data and the second time information being data and information transmitted from a subordinate terminal carried by the subordinate; and
a step of accumulating the collected instruction data and the first time information, and the collected site work data and the second time information in a storage device.

13. The data collection method according to claim 12, further comprising a step of constructing first work status data that is obtained by rearranging the site work data and the instruction data stored in the storage device in a chronological order.

14-15. (canceled)
